(19) United States
(12) Patent Application Publication
(10) Pub. No.: US 2025/0187652 A1
(43) Pub. Date: Jun. 12, 2025

(54) ELECTROMECHANICAL STEERING SYSTEM AND METHOD FOR OPERATING AN ELECTROMECHANICAL STEERING SYSTEM WITH EMERGENCY SHUTDOWN OF THE ACTUATOR

(71) Applicants: thyssenkrupp Presta AG, Eschen (LI); thyssenkrupp AG, Essen (DE)

(72) Inventors: Andor KOVÁCS, Budapest (HU); Tibor ECKER-SZÓRÁD, Erdotelek (HU)

(73) Assignees: thyssenkrupp Presta AG, Eschen (LI); thyssenkrupp AG, Essen (DE)

(21) Appl. No.: 18/967,884

(22) Filed: Dec. 4, 2024

(30) Foreign Application Priority Data
Dec. 6, 2023 (BE) BE 2023/5992

(51) Int. Cl. B62D 5/04

(52) U.S. Cl. CPC B62D 5/046; B62D 5/0421

(57) ABSTRACT

An electromechanical steering system comprises a steering shaft, via which a steering command can be specified by a steering handle, and a steering actuator having an electric motor and having a circuit arrangement assigned to the electric motor, wherein the steering actuator is designed to use the electric motor to convert a specified steering command into a steering movement of steerable wheels of the motor vehicle, wherein the circuit arrangement comprises a connection unit for connecting to a voltage source of a motor vehicle as the main energy source, a voltage supply unit for providing voltages required for operation, a main control unit, a safety unit designed to disconnect the electric motor from the voltage supply unit, an energy storage unit and an auxiliary control unit, wherein the auxiliary control unit is designed to actuate the safety unit for disconnecting the electric motor from the voltage supply unit in the event of a malfunction of the main control unit by energy provided by the energy storage unit.

### CROSS REFERENCE TO RELATED APPLICATION

This application is a U.S. Non-Provisional that claims priority to Belgian Patent Application No. BE 2023/5992, filed Dec. 6, 2023, the entire content of which is incorporated herein by reference.

### FIELD

The present disclosure relates to an electromechanical steering system, comprising a steering shaft.

### BACKGROUND

An electromechanical steering system is known, for example, from WO 2017/045729 A1. The problem with an electromechanical steering system of the type mentioned at the beginning is a serious fault in relation to the main control unit, for example due to a sudden failure of the internal circuitry, which leads to normal operation of the electric motor no longer being possible and the circuit arrangement assigned to the electric motor no longer being supplied with energy either. In the prior art, different approaches are known for dealing with such a problematic situation. For example, a steering system for a motor vehicle with a power steering system is known from DE 10 2015 115 755 A1, wherein the power steering system is supplied with energy in normal operation via an on-board electrical system of the motor vehicle. In the event of a fault with the on-board electrical system, provision is made for activation of an energy store, which can continue to supply power to the power steering system so that the steering system can continue to be used. CN 107444485 B discloses, in the event that the vehicle is taken out of service while driving, a system and a method for an electric vehicle using which a power steering system can continue to be used for a short time, so that a driver can still safely bring the vehicle to a stop. A monitoring controller ensures that a steering motor of the power steering system continues to be supplied with energy from a battery for the time until it comes to a stop. A similar technical teaching is disclosed by EP 3 206 936 B1, in which, for an electric vehicle, provision is also made, in the event of the loss of the main energy supply, to still provide a power steering system of the electric vehicle with sufficient energy for continued operation for a short time.

Other solutions for electromechanical steering systems are designed to electrically disconnect the electric motor from the system, leaving the vehicle able to continue to steer without steering assistance. By disconnecting the electric motor from the system in terms of circuitry, not only is damage to electronic components to be prevented, but in particular the intention is to prevent torques arising when steering due to the generator effect of the electric motor, said torques counteracting a desired steering movement and thus being able to block the steering of the vehicle. U.S. Pat. No. 10,833,614 B2 describes, in this context, an electric power steering device with an electric motor, wherein the electric motor is operated by means of a motor drive device. The motor drive device is intended to prevent the electric motor from acting as a generator in the event of support for a steering force being stopped by the electric motor due to a problem that has occurred. To this end, the motor drive device comprises two switchover circuits between the motor and the inverter circuit or between the inverter circuit and the power supply, which can disconnect the electrical connection with a time delay. To disconnect the electric motor in the event of a sudden drop in supply voltage, an electromechanical steering system with a protective circuit is also described in DE 10 2021 205 208 A1. One problem is to electrically disconnect the electric motor from the system even in the event of a sudden failure of the main control unit so that the steering system can be reliably put in a safe state.

Thus a need exists to provide an improved electromechanical steering system and an improved method for operating an electromechanical steering system, whereby in particular reliable moving of the electric motor into a safe state, in particular electrically disconnected from the system, and thus in particular reliable moving of the steering system to a safe state is achieved.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a simplified perspective illustration of an exemplary embodiment of a steering system designed according to the disclosure.

FIG. 2 shows a block diagram of an exemplary embodiment of a circuit arrangement of a steering system designed according to the disclosure.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The present disclosure relates to an electromechanical steering system comprising a steering shaft, via which a steering command can be specified by means of a steering handle, and a steering actuator having an electric motor and having a circuit arrangement assigned to the electric motor, wherein the steering actuator is designed to use the electric motor to convert a specified steering command into a steering movement of steerable wheels of a motor vehicle, wherein the circuit arrangement comprises a connection unit for connecting to a voltage source of a motor vehicle as the main energy source, a voltage supply unit for providing voltages required for operation, a main control unit and a safety unit designed to disconnect the electric motor from the voltage supply unit. The invention further relates to a method for operating a steering system of said type.

The proposed solution provides an electromechanical steering system comprising a steering shaft, via which a steering command can be specified by means of a steering handle, and a steering actuator having an electric motor and having a circuit arrangement assigned to the electric motor. The steering actuator of the steering system is designed to use the electric motor to convert a specified steering command into a steering movement of steerable wheels of a motor vehicle. The circuit arrangement of the steering system comprises a connection unit for connecting to a voltage source of a motor vehicle as the main energy source, in particular for connecting to an on-board electrical system of a motor vehicle. Furthermore, the circuit arrangement comprises a voltage supply unit for providing voltages required for operation, in particular for providing voltages required for normal operation for operating the electric motor and in particular for providing voltages required for emergency operation for disconnecting the electric motor from the electrical grid. In addition, the circuit arrangement of the steering system comprises a main control unit and a safety unit, wherein the safety unit is designed to disconnect the electric motor from the voltage supply unit. If the main control unit is functioning properly, it advantageously actuates the safety unit for disconnecting the electric motor from the voltage supply. In addition, the circuit arrangement comprises an energy storage unit and an auxiliary control unit, wherein the auxiliary control unit is designed to actuate the safety unit for disconnecting the electric motor from the voltage supply unit in the event of a malfunction of the main control unit by means of energy provided by the energy storage unit. Advantageously, therefore, in the event of a failure of the main control unit, the energy storage unit still provides sufficient energy for the auxiliary control unit to be able to electrically disconnect the electric motor and thus bring the electric motor and in particular the steering system into a safe state. In this way, when a motor vehicle is steered without support from the electric motor, the electric motor is advantageously prevented from building up a resistance torque opposed to the steering movement.

In particular, provision is made for the main control unit to be designed to actuate the electric motor. The main control unit advantageously comprises a converter unit, which preferably has a bridge circuit composed of MOSFETs (MOSFET: metal-oxide-semiconductor field-effect transistor) for the control of the electric motor. The safety unit may in particular comprise a phase separation unit, which preferably comprises a phase relay for each phase. The phase relays are advantageously actuatable in normal operation by the main control unit or by the main control unit and by the auxiliary control unit, and in emergency operation, in which the main control unit has failed, are advantageously actuatable by the auxiliary control unit in order to be able to move the electric motor and thus the steering system into a safe state. The phase relays are particularly advantageously actuatable by the main control unit or by the auxiliary control unit in the event of a sudden drop in the supply voltage. The auxiliary control unit is advantageously supplied with the energy required for the operation of the auxiliary control unit, in particular in the event of a failure of the main control unit. The required energy is advantageously provided by an energy storage unit, wherein the energy storage unit comprises in particular a capacitor for energy storage. The energy storage unit is preferably filled by means of a “filling device”, in particular a charge pump. The auxiliary control unit is further advantageously designed as a microcontroller unit. The auxiliary control unit advantageously has a logic circuit with which a malfunction of the main control unit can be identified, wherein the auxiliary control unit is advantageously designed to act on the safety unit, in the event of an identified malfunction, in particular in the event of a sudden failure of the main control unit, in order to move the electric motor and thus in particular also the steering system into a safe state, in particular in order to disconnect the electric motor from the system in terms of circuitry so that advantageously no steering resistance torque can be generated by the electric motor.

An advantageous configuration of the steering system thus makes provision for the auxiliary control unit to be designed to monitor voltages provided by the voltage supply unit. The auxiliary control unit is advantageously designed to identify a fault in relation to the voltages provided, in particular a sudden voltage drop of the voltages provided, and is thus advantageously designed to identify a deviation from normal operation of the steering system and in particular a failure of the main control unit. In particular, the auxiliary control unit is thus designed to identify the occurrence of a fault in relation to the main control unit, in particular for identifying a failure of the main control unit. The auxiliary control unit is advantageously further configured in this case, in the event of identification of such a fault, to actuate the safety unit in order to move the electric motor and thus in particular the steering system into a safe state.

According to a further, particularly advantageous configuration of the steering system, the circuit arrangement further comprises an energy storage supply unit for charging the energy storage unit, wherein the energy storage supply unit can also be referred to as a “filling device”. The energy storage supply unit is used to advantageously ensure that the energy storage unit is also sufficiently charged in the event of an occurring fault in relation to the voltage supply and can thus provide sufficient energy so that advantageously sufficient energy is available to be able to move the electric motor and thus in particular the steering system into the safe state. The energy storage supply unit is advantageously set up to be able to use a provided voltage in normal operation, in particular an on-board electrical system voltage. The circuit arrangement is advantageously designed in such a way that, after the steering system has started to be used, the energy storage unit is charged using the energy storage supply unit, so that the energy storage unit can advantageously supply the auxiliary control unit with the required voltage in the event of a sudden failure of the main control unit.

A further advantageous configuration makes provision for the energy storage supply unit or the “filling device” to be a step-up converter or a charge pump. In this way, the energy storage unit can advantageously be charged with a higher voltage compared to the on-board electrical system voltage provided via the connection unit, wherein the energy storage unit is realized in particular as a capacitor circuit. The energy storage unit is advantageously already charged shortly after start-up of the steering system in a motor vehicle, such that an energy supply for moving the electric motor into a safe state in the event of a sudden failure of the main control unit is ensured early. The energy storage supply unit, that is to say in particular the step-up converter or the charge pump, is therefore advantageously used for filling the energy store, which is used by the auxiliary control unit when the electric motor has to be switched off.

The electromechanical steering system furthermore advantageously comprises a sensor unit designed to provide the main control unit and/or the auxiliary control unit with sensor signals for the purpose of control. In particular, provision is made for the steering system to comprise multiple such sensor units. The voltage supply unit is advantageously designed to provide the at least one sensor unit with the energy required for operation, in particular a voltage required for operation of the at least one sensor unit. In particular, the sensor signals provided by the at least one sensor unit may relate to a steering angle set via the steering handle and/or a torque applied via the steering handle.

The method for operating an electromechanical steering system in a motor vehicle further proposed for solving the problem stated at the beginning, wherein the steering system comprises a steering shaft, via which a steering command can be specified by means of a steering handle, and a steering actuator having an electric motor and having a circuit arrangement assigned to the electric motor, wherein the steering actuator is designed to use the electric motor to convert a steering command into a steering movement of steerable wheels of a motor vehicle makes provision for the circuit arrangement to be connected via a connection unit to a voltage source of the motor vehicle as main energy source, and, in normal operation, for an energy storage unit of the circuit arrangement to be charged, in normal operation, for a voltage supply unit of the circuit arrangement to use the energy provided by the main energy source to provide voltages required for normal operation, and, in normal operation, for a main control unit to control the electric motor taking into account sensor signals provided, and in particular for the main control unit to disconnect the electric motor in terms of circuitry in the event of a deviation from normal operation. In the event of a malfunction in relation to the main control unit, in particular in the event of a failure of the main control unit, the voltage supply unit uses energy provided by the energy storage unit to provide energy to an auxiliary control unit of the circuit arrangement for actuating a safety unit for disconnecting the electric motor from the voltage supply unit, and the electric motor is disconnected from the voltage supply unit. In the event of a sudden failure of the main control unit in inventive operation of an electromechanical steering system, the electric motor can advantageously be moved into a safe state and it is thus possible to prevent the electric motor from producing steering resistance torques that adversely affect the steering.

In particular, provision is made for the energy storage unit to be charged by an energy storage supply unit, wherein the energy storage supply unit in particular is a step-up converter or a charge pump. The energy storage unit is realized in particular by a suitable capacitor circuit, which is integrated into the circuit arrangement. The energy storage unit is advantageously charged with a voltage that is higher than the supply voltage provided by the main energy source.

A particularly advantageous configuration of the method makes provision for the steering system to be designed as an electromechanical steering system configured according to the invention, which in particular has the features described above individually or in a suitable combination.

A solution for achieving safe steering without negative influences of the electric motor in the event of a sudden failure of the main control unit or the function of the main control unit thus advantageously makes provision for an auxiliary control unit to be provided with the energy required for the circuit disconnection of the electric motor, for which purpose in particular provision is made for an energy storage unit to be supplied with sufficient energy by an energy storage supply unit, that is to say a “filling device”.

In particular, provision may be made to replenish an energy storage unit with a higher voltage than the internal system voltage so that the energy storage unit can extend the power supply to the emergency shutdown logic systems and the actuator. In this way, the motor disconnection and thus the safe state is advantageously possible even after a failure of the main control unit.

In normal operation, a sensor advantageously supplies the signal to the main control unit, which operates the system under normal conditions. In the case of an emergency, that is to say in particular in the event of a sudden failure of the main control unit, the sensor advantageously provides the signal path to the auxiliary logic system, in particular an auxiliary control unit, wherein the signal can advantageously be used for plausibility testing. The system is then advantageously moved to a safe state by means of the auxiliary logic system.

A separate energy storage unit that can be diverted from the system supply is advantageously used, wherein the energy storage unit is preferably used with a charge pump or a step-up converter, which ensures that sufficient energy is stored for a safe shutdown in the event of a failure of the main power supply.

In the various figures, identical parts are generally provided with the same reference signs and are therefore also, in some cases, each explained only in conjunction with one of the figures.

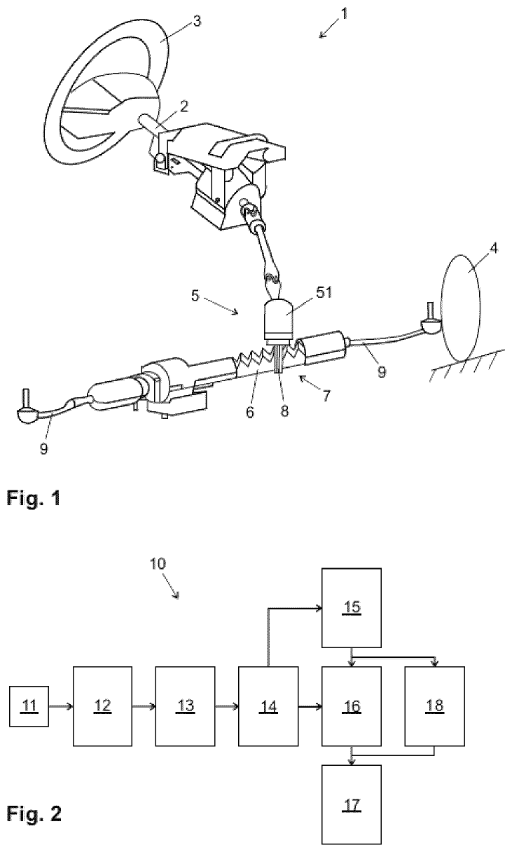

FIG. 1 shows a perspective simplified illustration of an electromechanical steering system 1 for a motor vehicle. The steering system 1 comprises a steering column with a steering shaft 2, with 2s a steering wheel being arranged as a steering handle 3 at the end of said steering shaft that faces a driver. A driver can turn the steering handle 3 in a known manner in order to enter a steering command. The steering shaft 2 is mechanically coupled to the steerable wheels 4 of a motor vehicle via a steering gear 7. In this exemplary embodiment, the steering gear 7 comprises a steering actuator 5 having an electric motor 51 and a pinion 8 driven by the electric motor 51 and a coupling rod 6 formed as a rack, on which the steering actuator 5 can act via the pinion 8 for adjusting a wheel steering angle of the steerable wheels 4. The steering gear 7 is thus designed for translating a rotational movement of the pinion 8 into a translational movement of the coupling rod 6 along the longitudinal axis thereof. In this exemplary embodiment, the coupling rod 6 of the steering system 1, which moves linearly along the longitudinal axis thereof, is mechanically coupled to a respective track rod 9 on both sides of the motor vehicle. In turn, the track rods 9 are each mechanically coupled to the vehicle wheels 4. In this way, the steering actuator 5 can convert a steering command specified via the steering handle 3 into a steering movement of the steerable wheels 4.

For the operation of the steering actuator 5, the steering system 1 has a circuit arrangement assigned to the electric motor 51, which circuit arrangement is not explicitly shown in FIG. 1. An advantageous configuration of such a circuit arrangement is discussed in more detail below still with reference to FIG. 2. The circuit arrangement is designed to electrically disconnect the electric motor 51 from the steering system 1 in the event of a failure of the supply voltage or in the event of a critical drop in the supply voltage. Due to the mechanical coupling of the steering handle 3 to the electric motor 51 of the steering actuator 5 via the steering shaft 2, in the event of a failure of the supply voltage for the electric motor 51, the electric motor 51 could act as a generator by turning the steering handle 3 and thus generate a steering resistance torque that counteracts a steering movement, which is advantageously prevented by the circuit arrangement. In a normal case, a main control unit of the circuit arrangement is designed to bring about the disconnection of the electric motor 51 from the steering system 1. If the main control unit fails, for example due to a fault in the internal circuits, in such an emergency the electric motor 51 is electrically disconnected from the steering system 1 using an auxiliary control unit of the circuit arrangement.

The electric motor 51 is in particular a synchronous motor, more particularly a permanent magnet synchronous motor, having at least three phase windings. If the steering system 1 is installed in a motor vehicle, the electric motor 51 is electrically conductively connected via the circuit arrangement to a main energy source, in particular the battery of a motor vehicle. The circuit arrangement to this end comprises a connection element, via which the circuit arrangement is electrically conductively connected to the main energy source and thus advantageously to the on-board electrical system. The main energy source provides the supply voltage for normal operation of the electric motor 51 of the steering system 1.

A possible advantageous configuration of a circuit arrangement 10 is shown in FIG. 2 in a block diagram. The circuit arrangement 10 can be connected to a voltage source of a motor vehicle via a connection unit 11 of the circuit arrangement 10. In particular, a connection to the on-board electrical system of a motor vehicle is made via the connection unit 11. A supply voltage for normal operation is thus provided via the connection unit 11. A system voltage provided via the connection unit 11 is provided in terms of circuitry to an energy storage supply unit 12, in particular a charge pump or a step-up converter, of the circuit arrangement 10. If a motor vehicle and thus the steering system is put into operation, the system voltage provided by means of start-up via the connection unit 11 is applied to the energy storage supply unit 12 as an input voltage, wherein an energy storage unit 13, in particular a suitably interconnected capacitor, is charged with the output voltage of the energy storage supply unit 12, which is greater than the input voltage.

The voltages required for operation are provided via a voltage supply unit 14 of the circuit arrangement 10. In particular, the voltage supply unit transforms the system voltage, that is to say the supply voltage of the main energy source, to the voltage required for the operation of the components of the circuit arrangement 10 and in particular for the operation of the electric motor 51. In normal operation, in particular the system voltage provided by the voltage supply unit 14 via the connection unit 11 for operation of a sensor unit 15 for providing the input signals for the main controller 18 for controlling the electric motor 51 and for providing the voltages for a voltage supply for the electric motor 51 is adapted accordingly. The circuit arrangement 10 further comprises an auxiliary control unit 16. The auxiliary control unit 16 is set up in this case, in the event of failure of the main control unit 18, to actuate a safety device 17 for disconnecting the electric motor 51 from the steering system 1. The auxiliary control unit 16 may furthermore be designed to monitor voltages provided by the voltage supply unit 14. The auxiliary control unit is advantageously also set up to identify when a fault occurs in relation to voltages provided by the voltage supply unit 14, in particular when a malfunction occurs in relation to the provision of the system voltage, more particularly when a sudden drop in the system voltage occurs. Such voltage drops may in this case indicate a failure of the main control unit 18. The auxiliary control unit 16 is thus designed in particular to identify a failure of the main control unit 18.

The voltage supply unit 14 is further designed, in the event of a malfunction of the main control unit 18, in particular in the event of a functional failure of the main control unit 18, to use energy provided by the energy storage unit 13 to continue to provide the auxiliary control unit 16 with a voltage required for operation, wherein the thus further operational auxiliary controller 16 is capable of actuating a safety unit 17 for disconnecting the electric motor 51 from the voltage supply unit 14 in the event of failure of the main control unit 18. The safety unit 17 is designed to disconnect the electric motor 51 from the voltage supply unit 14.

In particular, provision may be made for the circuit arrangement 10 to comprise a converter unit, in particular as a component of the main control unit 18 of the circuit arrangement 10, wherein the converter unit may comprise in particular a MOSFET bridge circuit, for example a four-quadrant actuator. The safety unit 17 of the circuit arrangement 10 also advantageously has a phase separation unit, wherein the phase separation unit has in particular one MOSFET as phase relay for each phase winding. In such a configuration, the connection to the electric motor 51 is advantageously performed via the phase separation unit. The auxiliary control unit 16 comprised by the circuit arrangement 10 is more advantageously formed as a microcontroller unit, which is advantageously designed for acting on the safety unit 17. In particular, the auxiliary control unit is designed to control the phase separation unit instead of the main control unit 18 and thus to electrically disconnect the electric motor 51 from the circuit arrangement 10 when the main control unit 18 has failed.

For operation of an electromechanical steering system 1, as explained in particular with reference to FIG. 1 and FIG. 2, in a motor vehicle, provision is made for the energy storage unit 13 to be charged by the energy storage supply unit 12, in particular in normal operation of the steering 2s system 1, the voltage supply unit 14 of the circuit arrangement 10 provides voltages required for normal operation using the energy provided by the main energy source and the main control unit 18 controls the electric motor 51 taking into account sensor signals provided by the sensor unit 15. In the event of a failure of the main control unit 18, the steering system 1 continues to operate in such a way that the voltage supply unit 14 uses the energy provided by the energy storage unit 13 to provide the auxiliary control unit 16 with energy for actuating the safety unit 17 for disconnecting the electric motor 51 from the voltage supply unit 14. The electric motor 51 is then disconnected from the voltage supply unit 14.

The exemplary embodiments illustrated in the figures and explained in conjunction therewith serve to explain the invention and have no limiting effect thereon.

### LIST OF REFERENCE SIGNS

1 Steering system
2 Steering shaft
3 Steering handle
4 Steerable wheel
5 Steering actuator
51 Electric motor
6 Coupling rod
7 Steering gear
8 Pinion
9 Track rod
10 Circuit arrangement
11 Connection unit
12 Energy storage supply unit
13 Energy storage unit
14 Voltage supply unit
15 Sensor unit
16 Auxiliary control unit
17 Safety unit
18 Main control unit

1. An electromechanical steering system, comprising:
a steering shaft, via which a steering command can be specified by a steering handle, and
a steering actuator having an electric motor and having a circuit arrangement assigned to the electric motor,
wherein the steering actuator is designed to use the electric motor to convert a specified steering command into a steering movement of steerable wheels of a motor vehicle,
wherein the circuit arrangement comprises a connection unit for connecting to a voltage source of a motor vehicle as the main energy source, a voltage supply unit for providing voltages required for operation, a main control unit and a safety unit designed to disconnect the electric motor from the voltage supply unit,
wherein the circuit arrangement further comprises an energy storage unit and an auxiliary control unit, wherein the auxiliary control unit is designed to actuate the safety unit for disconnecting the electric motor from the voltage supply unit in the event of a malfunction of the main control unit by energy provided by the energy storage unit.

2. The electromechanical steering system according to claim 1, wherein the auxiliary control unit is further designed to monitor voltages provided by the voltage supply unit.

3. The electromechanical steering system according to claim 2, wherein the auxiliary control unit is further designed to detect a fault in relation to the main control unit.

4. The electromechanical steering system according to claim 1, wherein the circuit arrangement further comprises an energy storage supply unit for charging the energy storage unit.

5. The electromechanical steering system according to claim 4, wherein the energy storage supply unit is a step-up converter.

6. The electromechanical steering system according to claim 4, wherein the energy storage supply unit is a charge pump.

7. The electromechanical steering system according to claim 1, further comprising a sensor unit designed to provide the main control unit and/or the auxiliary control unit with sensor signals for the purpose of control.

8. The electromechanical steering system according to claim 7, wherein the voltage supply unit is designed to provide a voltage required for the operation of the sensor unit.

9. A method for operating an electromechanical steering system in a motor vehicle, including a steering shaft, via which a steering command can be specified by a steering handle, and a steering actuator having an electric motor and having a circuit arrangement assigned to the electric motor, wherein the steering actuator is designed to use the electric motor to convert a steering command into a steering movement of steerable wheels of the motor vehicle, wherein the circuit arrangement is connected via a connection unit to a voltage source of the motor vehicle as main energy source, and wherein, in normal operation, the method comprises:
charging an energy storage unit of the circuit arrangement,
using, by a voltage supply unit of the circuit arrangement, the energy provided by the main energy source to provide voltages required for normal operation, and
controlling, by a main control unit, the electric motor taking into account sensor signals provided,
wherein, in the event of a malfunction in relation to the main control unit, the voltage supply unit uses the energy of an auxiliary control unit of the circuit arrangement provided by the energy storage unit to provide energy for actuating a safety unit for disconnecting the electric motor from the voltage supply unit, and the electric motor is disconnected from the voltage supply unit.

10. The method according to claim 9, wherein the energy storage unit is charged by an energy storage supply unit.
